(19) United States
(12) Patent Application Publication
(10) Pub. No.: US 2015/0063409 A1
(43) Pub. Date: Mar. 5, 2015

(54) METHOD OF HEATING A CRYOGENIC LIQUID

(71) Applicants: Bernard Juery, Medan (FR); Arnaud Fournet, Merignac (FR); Pascal Bennetot, Franqueville Saint Pierre (FR); Ronan Gauther, Saint Marcel (FR)

(72) Inventors: Bernard Juery, Medan (FR); Arnaud Fournet, Merignac (FR); Pascal Bennetot, Franqueville Saint Pierre (FR); Ronan Gauther, Saint Marcel (FR)

(73) Assignee: SNECMA, Paris (FR)

(21) Appl. No.: 14/346,594

(22) PCT Filed: Sep. 14, 2012
(86) PCT No.: PCT/FR2012/052053

§ 371 Date: Sep. 30, 2014

(30) Foreign Application Priority Data
Sep. 22, 2011 (FR) 11 58425

(51) Int. Cl. F17C 13/02; G01N 25/00; F17C 5/02

(52) U.S. Cl. CPC F17C 13/025; F17C 5/02; G01N 25/00
USPC 374/45; 62/45.1; 62/47.1

(57) ABSTRACT

A method of heating a cryogenic liquid contained in a cryogenic tank including a gas headspace. The method includes heating the cryogenic liquid by injecting gas at higher temperature under a free surface of the cryogenic liquid.

### BACKGROUND OF THE INVENTION

The present invention relates to heating a cryogenic liquid, and in particular to heating a cryogenic liquid contained in a tank with a gas headspace.

In certain cryogenic applications, in particular for technical tests and for scientific experiments, it may be desired to supply a cryogenic liquid at a precise temperature and at a precise pressure. For example, when testing cryogenic rocket engines, and in particular when performing cavitation tests on their pumps for feeding them with cryogenic propellants, a supply of a flow of cryogenic liquid close to its saturation point is being requested ever more frequently. In order to restrict the thickness of the walls of tanks in vehicles propelled by such rocket engines, so as to limit their weight, the trend is towards decreasing the pressure inside the tanks. Consequently, the liquid fed to the feed pumps during a genuine launch is close to the saturation point, thereby making cavitation phenomena more likely in the pumps. For cavitation tests on the ground, it is therefore desirable to be able to supply the cryogenic liquid at a pressure and at a temperature that are as close as possible to real conditions. Unfortunately, the cryogenic liquid in tanks on the ground is generally at a temperature that is substantially lower, and therefore further removed from the saturation point.

In order to increase the temperature of a cryogenic liquid contained in a tank having a gas headspace, i.e. a tank presenting a gaseous phase above a free surface of the cryogenic liquid, attempts have been made in particular to deliver energy thereto by blowing in a gas at a higher temperature. The gas has been injected into the gas headspace of the tank. Nevertheless, because of the very high specific heat of such cryogenic liquids, the time needed for heating a large volume of cryogenic liquid is normally very long. In addition, by heating the liquid from above, significant stratification arises of the temperature in the liquid, with higher temperature layers close to the free surface, and with colder layers close to the bottom, from where the liquid is normally extracted in order to feed a test bench. That solution is therefore found to be generally insufficient for supplying a cryogenic liquid at a temperature that is reasonably accurate and significantly higher than the initial temperature of the cryogenic liquid before it was heated. Furthermore, it does not enable a pump to be fed with liquid at a temperature that is constant over time.

### OBJECT AND SUMMARY OF THE INVENTION

The invention seeks to propose a method of heating a cryogenic liquid contained in a cryogenic tank having a gas headspace, which method makes it possible to heat the cryogenic liquid more quickly and more uniformly.

In at least one implementation of a method of the invention, this object is achieved by the fact that said cryogenic liquid is heated by injecting gas at higher temperature under the free surface of the cryogenic liquid.

By means of these provisions, heat exchange can take place over an entire column of liquid, thereby enabling heating to be more uniform, with the heating also being assisted by convective currents within the tank. After initially following a rising path along which the bubbles exchange heat with the liquid, the gas in the bubbles can then condense in part and supply the energy of its latent heat to the liquid.

In particularly simple manner, the injected gas may be a gaseous phase of the cryogenic liquid.

Nevertheless, other gases could be used as an alternative or in addition, at least providing they are chemically inert relative to the cryogenic liquid, and solidify only at a temperature that is significantly lower than the temperature of the cryogenic liquid in the tank, so as to avoid plugging the injection points; and if it is desired to be able subsequently to extract the cryogenic liquid with a certain degree of purity, it is desirable for such other gases to be immiscible therewith.

Advantageously, it is possible to perform degassing above the free surface of the cryogenic liquid while injecting gas under said surface so as to maintain the pressure of the gas headspace below a predetermined maximum pressure. By way of example, this maximum pressure may be predetermined as a function of a temperature to be reached. In particular, when the purpose of the heating is to be able subsequently to extract the cryogenic liquid at a pressure and at a temperature that are close to the saturation point of the cryogenic liquid, the degassing may be advantageous for approaching the saturation point, since injecting gas normally gives rise to an increase in the pressure in a closed tank. In addition, a pressure that is too high inside the tank could give rise to major safety problems.

In particular, said cryogenic liquid may be liquid hydrogen, since its specific heat is particularly high, which makes it particularly laborious to heat using other methods. Nevertheless, the method may also be envisaged for other cryogenic liquids.

In particularly advantageous manner, said gas may be injected through an extraction point for the cryogenic liquid, thus simplifying the pipework associated with the tank and avoiding any need to form additional orifices in the tank, which orifices could be harmful both in terms of thermal insulation of the tank and in terms of its mechanical strength.

The invention also provides a method of testing a cryogenic device. In at least one embodiment of this test method, a cryogenic liquid is heated in a tank having a gas headspace by injecting a gas at a higher temperature under a free surface of the cryogenic liquid, for the purpose of subsequently feeding the cryogenic device during at least one test of the cryogenic device. It is thus possible to feed the cryogenic device with a cryogenic liquid at a precise temperature during the test.

In particular, said cryogenic device may comprise at least one cryogenic liquid pump, the heating then enabling the pump to be fed with a cryogenic liquid close to its saturation point, in order to perform cavitation testing on the pump.

In particularly advantageous manner, a flow of gas may be injected into the gas headspace of the cryogenic tank during the test in order to maintain the pressure in the gas headspace above the saturation pressure of the cryogenic liquid. After the cryogenic liquid has been extracted from the cryogenic tank, this serves to avoid the pressure in the cryogenic tank dropping below the saturation point at the desired temperature, which would cause the liquid to vaporize and cool the remaining liquid while the test is taking place.

Nevertheless, after the test, it may also be advantageous to depressurize the gas headspace of the cryogenic tank to below the saturation pressure of the cryogenic liquid in order to cool the cryogenic liquid for a subsequent test, in particular when the cryogenic liquid needs to be supplied at a lower temperature for that subsequent test.

The invention also provides an installation for testing a cryogenic device, the installation including at least one cryogenic tank for a cryogenic liquid that is to be supplied to the cryogenic device. In at least one embodiment, the system also has a device for introducing a gas at a temperature higher than the temperature of the cryogenic liquid into the cryogenic tank under a free surface of the cryogenic liquid for the purpose of heating the cryogenic liquid.

### BRIEF DESCRIPTION OF THE DRAWINGS

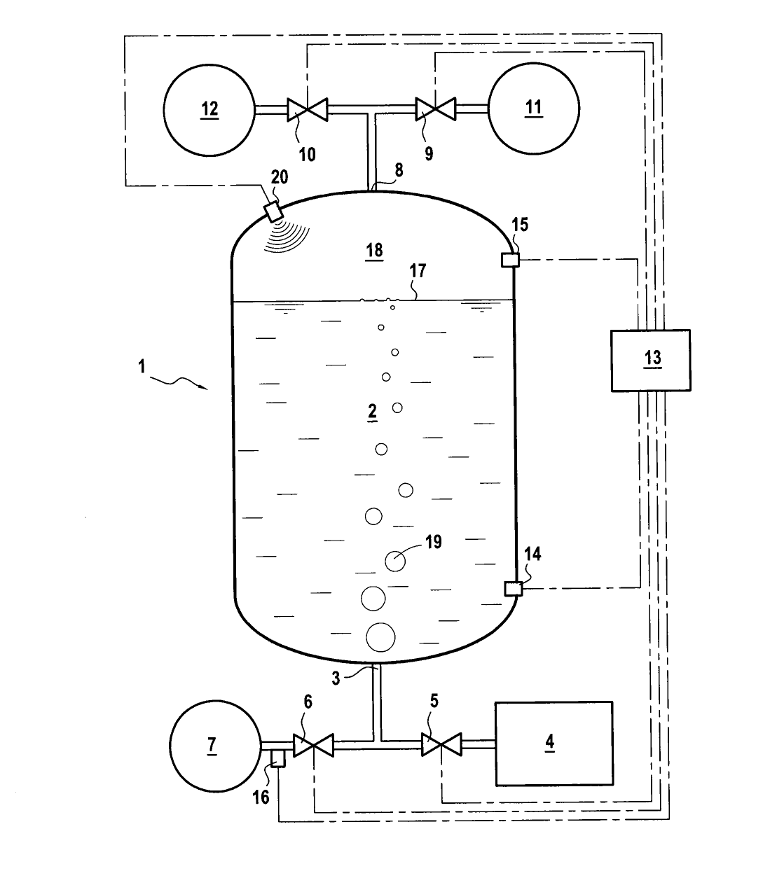

The invention can be well understood and its advantages appear better on reading the following detailed description of an implementation given by way of non-limiting example. The description refers to accompanying FIG. 1, which is a diagram showing a feed installation for testing a cryogenic device in an implementation of the invention.

### DETAILED DESCRIPTION OF THE INVENTION

A feed installation 1 in an embodiment of the invention as shown in FIG. 1 comprises a cryogenic tank 1 for receiving liquid hydrogen 2 for feeding a test bench 4 with liquid hydrogen at controlled temperature and pressure. By way of example, the test bench 4 may be designed to test the cooling and/or the operation of elements of cryogenic rocket engines, in particular pumps for feeding propellants to such rocket engines. It may also be for the purpose of testing such a rocket engine as a whole. Nevertheless, the installation and the method of the invention may also be used for testing other types of cryogenic device.

At the bottom of the cryogenic tank 1, the tank has a liquid hydrogen extraction point in the form of an extraction pipe 3 that is connected to the test bench 4 via a valve 5. Nevertheless, the extraction pipe 3 is also connected via another valve 6 to first tank 7 of gaseous hydrogen. At its top, the cryogenic tank 1 also presents a pressurization and degassing point 8 that is connected via corresponding valves 9 and 10 to second and third tanks 11 and 12 of gaseous hydrogen. The second gaseous hydrogen tank 11 is for receiving pressurizing gaseous hydrogen for pressurizing the cryogenic tank 1. In contrast, the third gaseous hydrogen tank 12 is for receiving gaseous hydrogen coming from the cryogenic tank 1 while it is being degassed.

The valves 5, 6, 9, and 10 are connected for control purposes to a control unit 13, normally in the form of an electronic processor. This control unit 13 is also connected to at least one temperature sensor 14 and to at least one pressure sensor 15 located respectively at the bottom and at the top of the cryogenic tank 1; it is also connected to a flow rate sensor 16 for sensing the flow rate in the pipe between the first gaseous hydrogen tank 7 and the cryogenic tank 1, and to a level sensor 20 for sensing the level in the cryogenic tank 1.

In operation, liquid hydrogen 2 forms a liquid column between the bottom of the tank 1 and a free surface 17. Above the free surface 17 and up to its top, the tank is occupied by gaseous hydrogen forming a gas headspace 18, thus enabling the pressure inside the cryogenic tank 1 to be regulated. Initially, the liquid hydrogen 2 is at a temperature T₀ that should be raised up to a temperature T₁ for feeding the test bench 4 during a first test. In the gas headspace 18 there is an initial pressure p_{0,c}. The initial pressure p_{0,f} at the bottom of the cryogenic tank 1 corresponds to this initial pressure P_{0,c} plus the pressure exerted by the column of liquid. The pressure p_{0,r1} in the first gaseous hydrogen tank 7 is clearly greater than this initial pressure p_{0,f} at the bottom of the cryogenic tank 1.

In order to heat the liquid hydrogen 2, the valve 6 is opened and a flow of gaseous hydrogen is introduced into the cryogenic tank 1 via the extraction pipe 3 at a flow rate Dᵣ₁. At the end of the pipe, this flow rate Dᵣ₁ forms bubbles 19 of an initial diameter d, which bubbles rise through the liquid hydrogen column 2 and exchange heat therewith through their surfaces. For a given gas flow rate, the heat exchange area, and thus the amount of heat exchanged, increases with decreasing size of the bubbles. By way of example, Table 1 shows the quantity of gaseous hydrogen at ambient temperature (293 K) needed for transmitting 120 megajoules (MJ) of heat while rising through a liquid hydrogen column at 23.2 K over a height of 7 meters (m) for various different bubble diameters:

TABLE 1
Heat transmitted as a function of bubble size

| | Total weight | | Energy |
|---|---|---|---|
| Bubble | of gaseous | Number of | transmitted by |
| diameter d | hydrogen | bubbles | each bubble |
| [in mm] | [in kg] | [in thousands] | [in J] |
| 10 | 34 | 333333 | 0.36 |
| 20 | 34 | 40079 | 2.99 |
| 30 | 46 | 16160 | 7.42 |
| 40 | 56 | 8405 | 14.28 |
| 50 | 65 | 5009 | 23.96 |
| 60 | 73 | 3252 | 36.9 |
| 70 | 81 | 2256 | 53.19 |
| 80 | 87 | 1630 | 73.59 |
| 90 | 93 | 1220 | 98.3 |
| 100 | 99 | 943 | 127.21 |

This heat transmitted by the bubbles of gaseous hydrogen to the liquid hydrogen 2 corresponds to the specific heat of gaseous hydrogen between its initial temperature at the bottom of the cryogenic tank and its condensation temperature, and also to its latent heat of condensation. Thus, under optimal conditions, the total flow rate Dᵣ₁ of gaseous hydrogen condenses, and the bubbles 19 are liquefied before reaching the free surface 17. Nevertheless, if the initial pressure p_{0,c} is not high enough, the bubbles 19 will initially pass through the liquid hydrogen column 2 without reaching their saturation point. Since the degassing valve 10 is initially closed, if the flow rate Dᵣ₁ of gaseous hydrogen thus reaches the gas headspace 18, it will cause the pressure of the gas headspace 18 to increase up to a pressure p_{1,c} at which the gas in the bubbles 19 does indeed reach its saturation point before reaching the free surface 17.

Even above this pressure p_{1,c}, the pressure inside the cryogenic tank 1 continues to rise, although substantially more slowly, so long as gaseous hydrogen is being injected via the pipe 3, as a result of the rise in the level of liquid hydrogen 2 inside the cryogenic tank 1, and above all as a result of the liquid hydrogen 2 evaporating because of the heat received from the bubbles 19. At the same time, the temperature of the liquid hydrogen 2 rises up to its saturation temperature. Thus, the heating of the liquid hydrogen 2 is governed by the saturation temperature, and thus by pressure. In order to avoid excess pressure that can damage the cryogenic tank 1, and also in order to avoid the liquid hydrogen 2 exceeding the pressure p_{2,f} at which it is desired to extract it from the cryogenic tank 1 during the first test, it is possible to proceed with controlled degassing by opening the degassing valve 10 so as to allow a flow rate D_{r3,1} of hydrogen to escape to the third hydrogen tank 12 in order to avoid exceeding a corresponding pressure P_{2,c} in the gas headspace 18.

When the desired temperature and pressure are established in the liquid hydrogen 2, it is possible to close the valves 6 and 10 and to proceed with the first test. In order to feed the test bench 4 with liquid hydrogen 2, the valve 5 is opened so as to extract a flow rate D_{e,1} of liquid hydrogen at the T₂ and pressure p_{2,f} from the bottom of the cryogenic tank. At the same time, in order to maintain this pressure p_{2,f} in the liquid hydrogen 2 and the corresponding pressure p_{2,c} in the gas headspace 18, or in order to increase them, the valve 9 may be opened so as to allow an equivalent volume flow rate of gaseous hydrogen to pass from the second gaseous hydrogen tank 11 to the gas headspace 18 in the cryogenic tank. This serves to maintain test conditions, and above all to avoid the pressure inside the cryogenic tank 1 dropping below the saturation pressure p_{2,s} of hydrogen at the temperature T₂ while liquid hydrogen 2 is being extracted, since that would cause the liquid hydrogen 2 to boil and would therefore cool the liquid hydrogen.

At the end of this first test, the valves 5 and 9 are closed once more. If it is desired subsequently to proceed with a second test in which the liquid hydrogen 2 is delivered at a lower temperature, it is possible to cool the liquid hydrogen by degassing gaseous hydrogen at a flow rate D_{r3,2} to the third gaseous hydrogen tank 12 by opening the degassing valve 10 so as to drop below the saturation pressure p_{3,s} of hydrogen at the temperature T₃ of the liquid hydrogen at the beginning of this cooling. The vaporization of the liquid hydrogen 2 absorbs a quantity of heat equivalent to the latent heat of the weight of liquid hydrogen that changes to the gaseous state, and the remaining liquid hydrogen 2 cools in corresponding manner so as to reach a desired temperature T₄. Thereafter, the pressure of the gas headspace 18 can be regulated with the valves 9 and 10 so as to obtain the desired pressure p_{4,c} in the gas headspace 18, which pressure is higher than that corresponding to the saturation point at the temperature T₄. The valve 5 can then be opened once more in order to feed the test bench 4 with liquid hydrogen at the temperature T₄ and at the pressure p_{4,f} at the bottom of the cryogenic tank.

Throughout all of these operations, the opening and the closing of the valves 5, 6, 9, and 10 may be controlled by the control unit 13 as a function of instructions from a user and/or as a function of measurements transmitted by the sensor 14, 15, 16, and 20. It should be added that the pressure at the bottom of the cryogenic tank 1 can be estimated on the basis of the pressure in the gas headspace 18 and on the basis of the level of the liquid hydrogen, as picked up respectively by the pressure sensor 15 and by the level sensor 20.

In an example of a step of heating liquid hydrogen in the described implementation, an initial volume of 65.7 cubic meters (m³) of liquid hydrogen 2 forming a liquid column having a depth of 7 m in a cryogenic tank 1 with a volume of 75 m³ was heated from a temperature T₀ of 20.7 K to a temperature T₂ of 23.2 K in a time t_{c} of 9000 seconds (s) by injecting gaseous hydrogen at a constant flow rate Dᵣ₁ of 4 grams per second (g/s) through an extraction pipe having a diameter of 3 millimeters (mm) to 4 mm into the cryogenic tank 1, the gaseous hydrogen being taken from a first gaseous hydrogen tank 7 at ambient temperature (about 293 K) and at a pressure of 0.57 megapascals (MPa). During that heating, the pressure in the gas headspace 18 of the cryogenic tank rose from an initial pressure p_{0,c} of 0.12 MPa to a pressure p_{2,c} of 0.29 MPa.

In an example of a step of cooling liquid hydrogen in the described implementation, an initial volume of 66.2 m³ of liquid hydrogen 2 forming a liquid column with a depth of 7 m in a cryogenic tank 1 having a volume of 75 m³ was cooled from a temperature T₃ of 23.2 K to a temperature T₄ of 20.7 K in a time t_{c} of 5400 s by degassing gaseous hydrogen at a flow rate D_{r3,2} of about 50 g/s to the third gaseous hydrogen tank 12. During the degassing, the pressure in the gas headspace 18 of the cryogenic tank began by dropping from an initial pressure p_{3,c} of 0.35 MPa to the saturation pressure p_{3,s} of 0.22 MPa of liquid hydrogen at the temperature T₃ of 23.2 K. Thereafter, with continued degassing, the change of state of a portion of the liquid hydrogen 2 caused the temperature of the remaining liquid hydrogen 2 to drop to the temperature T₄ of 20.7 K, while the pressure in the gas headspace 18 followed the saturation curve down to a pressure p_{4,c} of 0.12 MPa. At the end of the cooling step there remained 62.2 m³ of liquid hydrogen 2 in the cryogenic tank 1.

Although the invention is described above with reference to a specific implementation, it is clear that various modifications and changes may be made on the examples without going beyond the general scope of the invention as defined by the claims. In particular, although the cryogenic liquid in the implementation described is liquid hydrogen, other cryogenic liquids can be heated and cooled in controlled manner in the same way. Furthermore, the heating gas may be injected not merely through a single pipe, but through a manifold having a plurality of orifices so as to decrease the size of the bubbles, and thus improve the efficiency of heat exchange. Individual characteristics of the various implementations mentioned may naturally be combined in additional implementations. Consequently, the description of the drawings should be considered as being in a sense that is illustrative rather than restrictive.

1-10. (canceled)

11. A method of heating a cryogenic liquid contained in a cryogenic tank including a gas headspace, the method comprising:
heating the cryogenic liquid by injecting gas at a higher temperature under a free surface of the cryogenic liquid.

12. The method of heating according to claim 11, wherein the injected gas is a gaseous phase of the cryogenic liquid.

13. The method of heating according to claim 11, further comprising performing degassing above the free surface of the cryogenic liquid while injecting gas below the free surface to avoid pressure in the gas headspace exceeding a predetermined maximum pressure.

14. The method of heating according to claim 11, wherein the gas is injected through an extraction point for the cryogenic liquid.

15. The method of heating according to claim 11, wherein the cryogenic liquid is liquid hydrogen.

16. A method of testing a cryogenic device, comprising:
heating a cryogenic liquid contained in a cryogenic tank including a gas headspace by injecting gas at a higher temperature under a free surface of the cryogenic liquid; and
subsequently feeding the cryogenic device during at least one test of the cryogenic device.

17. The method of testing according to claim 16, wherein the cryogenic device includes at least one cryogenic liquid pump.

18. The method of testing according to claim 16, wherein a flow of gas is injected into the gas headspace of the cryogenic tank during the test to maintain pressure in the gas headspace above a saturation pressure of the cryogenic liquid.

19. The method of testing according to claim 16, further comprising depressurizing the gas headspace of the cryogenic tank to below a saturation pressure of the cryogenic liquid after the test to cool the cryogenic liquid for a subsequent test.

20. A feed installation for testing a cryogenic device, the feed installation comprising:
at least one cryogenic tank for a cryogenic liquid for supplying to the cryogenic device; and
a device for introducing a gas at a temperature higher than a temperature of the cryogenic liquid into the tank under a free surface of the cryogenic liquid for heating the cryogenic liquid.
